(19) United States
(12) Patent Application Publication
(10) Pub. No.: US 2015/0063064 A1
(43) Pub. Date: Mar. 5, 2015

(54) METHODS AND SYSTEMS FOR ATTENUATING NOISE IN SEISMIC DATA

(71) Applicant: PGS Geophysical AS, Oslo (NO)

(72) Inventor: Gert-Jan Adriaan van Groenestjin, Voorschoten (NL)

(73) Assignee: PGS Geophysical AS, Oslo (NO)

(21) Appl. No.: 14/107,619

(22) Filed: Dec. 16, 2013

Related U.S. Application Data
(60) Provisional application No. 61/873,066, filed on Sep. 3, 2013.

(51) Int. Cl. G01V 1/30

(52) U.S. Cl. CPC G01V 1/30; G01V 1/38
USPC 367/21

(57) ABSTRACT

The disclosure presents computational systems and methods for attenuating noise in seismic data. The seismic data may be recorded by distributed sensors in response to acoustic signals emanating from one or more sources activated at approximately the same location with a time delay between activations of the one or more sources. The system and methods form an initial gather of traces from the seismic data and generate time-shifted gathers based on the initial gather and the time delays between activation of the sources. A realization gather is formed from traces selected from the initial gather and the time-shifted gathers. Noise in the seismic data is attenuated in the realization gather and may be removed. The realizations gathers may be used to generate high-resolution seismic images of the subterranean formation and enable quantitative seismic interpretation and improved reservoir monitoring.

### CROSS-REFERENCE TO A RELATED APPLICATION

This application claims the benefit of Provisional Application No. 61/873,066, filed Sep. 3, 2013.

### BACKGROUND

In the past few decades, the petroleum industry has invested heavily in the development of marine seismic survey techniques that yield knowledge of subterranean formations beneath a body of water in order to find and extract valuable mineral resources, such as oil. High-resolution seismic images of a subterranean formation are essential for quantitative seismic interpretation and petroleum reservoir monitoring. For a typical marine seismic survey, an exploration-seismology vessel tows a seismic source, and the same vessel, or another vessel, tows one or more streamers that form a seismic data acquisition surface below the surface of the water and above a subterranean formation to be surveyed for mineral deposits. The vessel contains seismic acquisition equipment, such as navigation control, seismic source control, seismic receiver control, and recording equipment. The seismic source control activates the seismic source, which is typically an array of source elements, such as air guns or marine vibrators, to produce acoustic signals at selected times. Each acoustic signal is a sound wave that travels down through the water and into the subterranean formation. At each interface between different types of rock, a portion of the sound wave is transmitted and another portion is reflected back into the body of water as a wavefield that propagates toward the water surface. The streamers towed behind the vessel are elongated cable-like structures equipped with a number of seismic receivers or multi-component sensors that detect pressure and/or particle motion wavefields associated with the wavefields reflected back into the water from the subterranean formation.

In order to produce focused seismic images of a subterranean formation, accurate pressure and velocity wavefield data is desired. However, obtaining an accurate characterization of the pressure and velocity wavefields can be difficult because the measured wavefields are often contaminated with noise. Seismic energy generated by a source used to simultaneously survey a neighboring subterranean formation, towing noise, barnacle noise, or blended simultaneous source energy are just a few examples of noise that contaminate the measured wavefields. As a result, researchers, geophysicists, and practitioners of exploration-seismology-related analytical methods continue to seek computationally efficient approaches that effectively reduce noise in seismic data so that the seismic data can be used to generate accurate images of a subterranean formation.

### DESCRIPTION OF THE DRAWINGS

FIGS. 1A-1B show side-elevation and top views of an example geophysical seismic data acquisition system.

FIG. 2 shows a side-elevation view of marine seismic data acquisition system with a magnified view of a receiver.

FIG. 3A shows an example of acoustic energy ray paths emanating from a source.

FIGS. 3B-3D shows plots of gathers.

FIG. 4 shows a plot of different ways seismic data collected in a survey may be sorted into domains.

FIG. 5 shows sail lines of an example marine survey.

FIG. 6A shows an example of a gather associated with activation of one source.

FIG. 6B shows an example of a initial gather resulting from activation of three sources at approximately the same shot location.

FIG. 7 shows an example of a wavefield represented in a first time-shifted gather.

FIG. 8 shows an example of a wavefield represented in a second time-shifted gather.

FIG. 9 shows examples of a trace selected from the initial gather in FIG. 6B and the first and second time-shifted gathers in FIGS. 7 and 8, respectively.

FIG. 10 shows a magnified view of traces obtained from an initial gather and first and second time-shifted gathers.

FIG. 11 shows twelve randomly selected traces from three example gathers.

FIG. 12 shows an example of a realization gather.

FIG. 13 shows an example of a realization gather G after muting.

FIGS. 14A-14C show an example of applying muting to the initial gather and time-shifted gathers shown in FIG. 9.

FIG. 15 shows a flow-control diagram of a computational routine for attenuating noise in seismic data.

FIG. 16 shows an example of a generalized computer system that executes efficient methods for attenuating noise in seismic data.

### DETAILED DESCRIPTION

This disclosure presents computational systems and methods for attenuating noise in seismic data. In one aspect, the seismic data may be recorded by sensors located along streamers towed by a survey vessel in response to acoustic signals emanating from the sources activated one at a time at approximately the same location. The system and methods form an initial gather of traces from the seismic data and generate time-shifted gathers based on the initial gather and time delays between activation of the sources. A realization gather is formed from traces selected from the initial gather and the time-shifted gathers. Noise in the seismic data is attenuated in the realization gather and may be removed. The realizations gathers may be used to generate high-resolution seismic images of the subterranean formation with reduced noise and enable quantitative seismic interpretation and improved reservoir monitoring, which often results in significant costs savings during hydrocarbon exploration, production, and extraction operations.

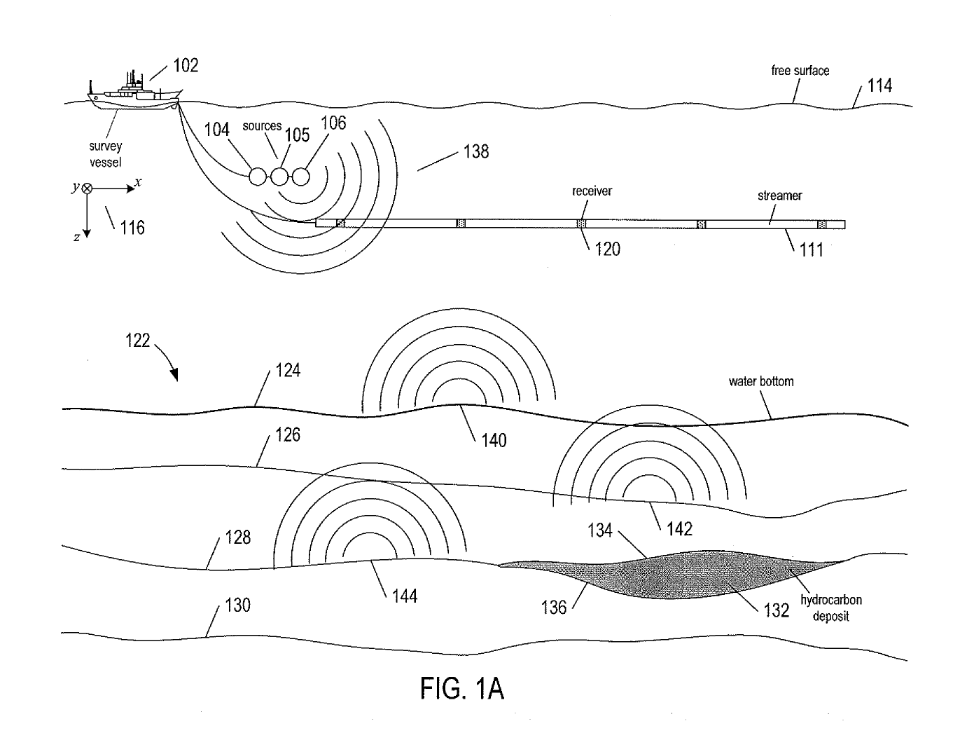

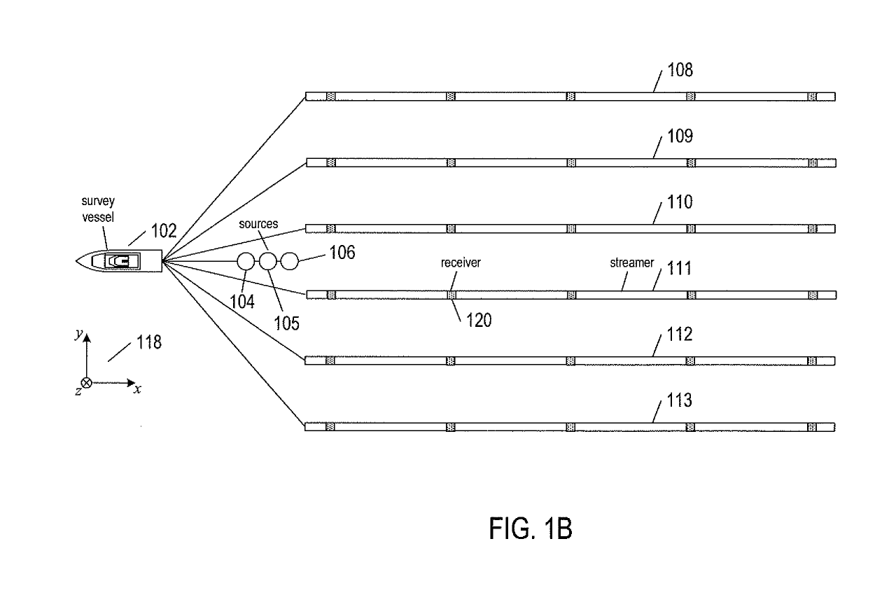

FIGS. 1A-1B show side-elevation and top views, respectively, of an example geophysical seismic data acquisition system composed of an exploration survey vessel 102 towing three sources 104-106 and six separate streamers 108-113 beneath a free surface 114 of a body of water. The body of water can be an ocean, a sea, a lake, or a river, or any portion thereof. In this example, each streamer is attached at one end to the survey vessel 102 via a streamer-data-transmission cable. The streamers 108-113 form a planar horizontal data acquisition surface with respect to the free surface 114. However, in practice, the data acquisition surface may be smoothly varying due to active sea currents and weather conditions. In other words, although the streamers 108-113 are illustrated in FIGS. 1A and 1B and subsequent figures as straight and substantially parallel to the fee surface 114, in practice, the towed streamers may undulate as a result of dynamic conditions of the body of water in which the streamers are submerged. A data acquisition surface is not limited to having a planar horizontal orientation with respect to the free surface 114. The streamers may be towed at depths that angle the data acquisition surface with respect to the free surface 114 or one or more of the streamers may be towed at different depths. A data acquisition surface is not limited to six streamers as shown in FIG. 1B. In practice, the number of streamers used to form a data acquisition surface can range from as few as one streamer to as many as 20 or more streamers. It should also be noted that the number of sources is not limited to three sources. In practice, the number of sources selected to generate acoustic energy may range from as few as two sources to more than three sources.

FIG. 1A includes an xz-plane 116 and FIG. 1B includes an xy-plane 118 of the same Cartesian coordinate system having three orthogonal, spatial coordinate axes labeled x, y and z. The coordinate system is used to specify orientations and coordinate locations within the body of water. The x-direction specifies the position of a point in a direction parallel to the length of the streamers (or a specified portion thereof when the length of the streamers are curved) and is referred to as the “in-line” direction. The y-direction specifies the position of a point in a direction perpendicular to the x-axis and substantially parallel to the free surface 114 and is referred to as the “cross-line” direction. The z-direction specifies the position of a point perpendicular to the xy-plane (i.e., perpendicular to the free surface 114) with the positive z-direction pointing downward away from the free surface 114. The streamers 108-113 are long cables containing power and data-transmission lines that connect receivers represented by shaded rectangles 120 spaced-apart along the length of each streamer to seismic acquisition equipment and data-storages devices located on board the survey vessel 102.

Streamer depth below the free surface 114 can be estimated at various locations along the streamers using depth measuring devices attached to the streamers. For example, the depth measuring devices can measure hydrostatic pressure or utilize acoustic distance measurements. The depth measuring devices can be integrated with depth controllers, such as paravanes or water kites that control and maintain the depth and position of the streamers as the streamers are towed through the body of water. The depth measuring devices are typically placed at intervals (e.g., about 300 meter intervals in some implementations) along each streamer. Note that in other implementations buoys may be attached to the streamers and used to maintain the orientation and depth of the streamers below the free surface 114.

FIG. 1A shows a cross-sectional view of the survey vessel 102 towing the sources 104-106 one after another and the streamers above a subterranean formation 122. In this example, the sources 104-106 are arranged in a line in the in-line direction so that the second source 105 and the third sources 106 follow the path of the first source 104. In alternative implementations, the sources 104-106 do not have to be aligned with one another and track the same path. In general, the multiple sources may each follow a different path in the in-line direction or any number of the sources may follow the same path in the in the in-line direction while other sources follow different paths in the in-line direction. Curve 124 represents a top surface of the subterranean formation 122 located at the bottom of the body of water. The subterranean formation 122 is composed of a number of subterranean layers of sediment and rock. Curves 126, 128, and 130 represent interfaces between subterranean layers of different compositions. A shaded region 132, bounded at the top by a curve 134 and at the bottom by a curve 136, represents a fluid-rich subterranean deposit, the depth and positional coordinates of which may be determined by analysis of seismic data collected during a marine seismic survey. As the survey vessel 102 moves over the subterranean formation 120, each of the sources 104-106 is activated at approximately the same shot location as described below to produce an acoustic signal called a “shot” at spatial and/or temporal intervals. In other embodiments, the sources 104-106 may be towed by one survey vessel and the streamers may be towed by a different survey vessel. Each of the sources 104-106 may be an air gun, marine vibrator, or each of the sources may be composed of an array of air guns and/or marine vibrators. FIG. 1A illustrates an acoustic signal expanding outward from the source 106 as a pressure wavefield 138 represented by semicircles of increasing radius centered at the source 106. The outwardly expanding wavefronts from the sources may be spherical but are shown in vertical plane cross section in FIG. 1A. The outward and downward expanding portion of the pressure wavefield 138 is called the “primary wavefield,” which eventually reaches the surface 124 of the subterranean formation 122, at which point the primary wavefield is partially reflected from the surface 124 and partially refracted downward into the subterranean formation 122, becoming elastic waves within the subterranean formation 122. In other words, in the body of water, the acoustic signal is composed of compressional pressure waves, or P-waves, while in the subterranean formation 122, the waves include both P-waves and transverse waves, or S-waves. Within the subterranean formation 122, at each interface between different types of materials or at discontinuities in density or in one or more of various other physical characteristics or parameters, downward propagating waves are partially reflected and partially refracted. As a result, each point of the surface 124 and each point of the interfaces 126, 128, and 130 is a reflector that becomes a potential secondary point source from which acoustic and elastic wave energy, respectively, may emanate upward toward the receivers 120 in response to the acoustic signal generated by the source 106 and downward-propagating elastic waves generated from the pressure impulse. As shown in FIG. 1A, secondary waves of significant amplitude may be generally emitted from points on or close to the surface 124, such as point 140, and from points on or very close to interfaces in the subterranean formation 122, such as points 142 and 144.

The secondary waves may be generally emitted at different times within a range of times following the initial acoustic signal. A point on the surface 124, such as the point 140, may receive a pressure disturbance from the primary wavefield more quickly than a point within the subterranean formation 122, such as points 142 and 144. Similarly, a point on the surface 124 directly beneath the source 106 may receive the pressure disturbance sooner than a more distant-lying point on the surface 124. Thus, the times at which secondary and higher-order waves are emitted from various points within the subterranean formation 122 may be related to the distance, in three-dimensional space, of the points from the activated source.

Acoustic and elastic waves, however, may travel at different velocities within different materials as well as within the same material under different pressures. Therefore, the travel times of the primary wavefield and secondary wavefield emitted in response to the primary wavefield may be functions of distance from the sources 104-106 as well as the materials and physical characteristics of the materials through which the primary wave travels. In addition, the secondary expanding wavefronts may be altered as the wavefronts cross interfaces and as the velocity of sound varies in the media are traversed by the wave. The superposition of waves emitted from within the subterranean formation 122 in response to the primary wavefield may be a generally complicated wavefield that includes information about the shapes, sizes, and material characteristics of the subterranean formation 122, including information about the shapes, sizes, and locations of the various reflecting features within the subterranean formation 122 of interest to exploration seismologists.

Secondary wavefronts that travel directly from the surface 124 or a subterranean interface to the receivers without experiencing reflections from the free surface or other interfaces are called “primary reflections” or simply “primaries.” On the other hand, secondary wavefronts that experience more than one subsurface reflection, subterranean reflection and/or reflections from the free surface 114 before being detected by the receivers are called “multiple reflections” or simply “multiples.” For example, multiple reflections include reflections from an interface that are subsequently reflected from the free surface back down into the subterranean formation 124 where the acoustic energy is reflected and subsequently detected by the receivers.

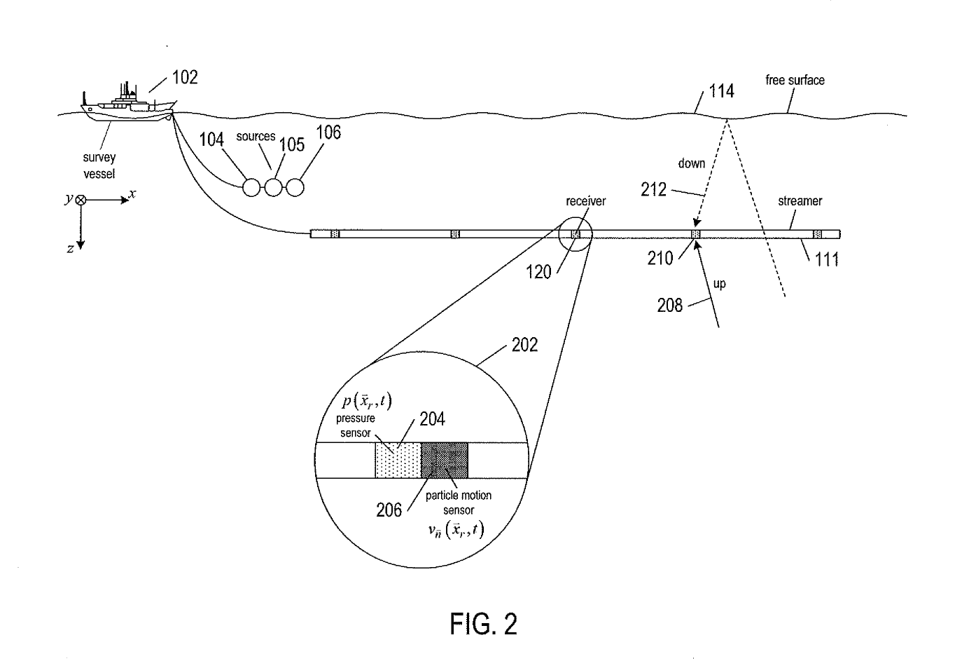

Each receiver 120 may be a dual sensor including a particle motion sensor that detects particle motion, velocities, or accelerations over time and a pressure sensor that detects variations in water pressure over time. FIG. 2 shows a side-elevation view of the marine seismic data acquisition system with a magnified view 202 of the receiver 120. The magnified view 202 reveals that the receiver 120 may be a dual sensor composed of a pressure sensor 204 and a particle motion sensor 206. The pressure sensor may be a hydrophone. Each pressure sensor measures changes in hydrostatic pressure over time and produces pressure data denoted by p(\vec{x},t), where \vec{x} represents the Cartesian coordinates (x,y,z) of the receiver, and t represents time. The motion sensors may be responsive to water motion. In general, particle motion sensors detect particle motion in a direction normal to the orientation of the particle motion sensor and may be responsive to such directional displacement of the particles, velocity of the particles, or acceleration of the particles. The motion sensor data produced by the particle motion sensors may be converted to particle motion velocity data. For example, when motion sensors that are responsive to position are used, the motion sensor data may be differentiated to convert the data to particle motion velocity data. Likewise, when motion sensors that are responsive to acceleration (i.e., accelerometers) are used, the particle acceleration data may be integrated to convert the data to particle motion velocity data. The resulting data produced by the motion sensors may be direction dependent particle velocity data denoted by v_{\vec{n}}(\vec{x},t), where unit normal vector \vec{n} points in the direction particle motion is measured. The particle motion sensors are typically oriented so that the particle motion is measured in the vertical direction (i.e., \vec{n}=(0,0,z)) in which case v_{z} (\vec{x},t) is called the vertical velocity data. Alternatively, the receivers may include two additional particle motion sensors that measure particle motion in two other directions, \vec{n}₁ and \vec{n}₂, that are orthogonal to \vec{n} (i.e., \vec{n}·\vec{n}₁=\vec{n}·\vec{n}₂=0, where “·” is the scalar product) and orthogonal to one another (i.e., \vec{n}₁·\vec{n}₂=0). In other words, the three particle motion sensors located at a receive measure particle motion in three orthogonal directions. For example, a receiver may also include a particle motion sensor that measures the wavefield in the in-line direction in order to obtain the inline velocity wavefield, vₓ(\vec{x},t), and a particle motion sensor that measures the wavefield in the cross-line direction in order to obtain the cross-line velocity wavefield, v_{y}(\vec{x},t). The pressure and particle velocity data comprise the seismic data. The streamers 108-113 and the survey vessel 102 may include sensing electronics and data-processing facilities that allow measurements from each receiver to be correlated with absolute positions on the free surface 114 and absolute three-dimensional positions with respect to an arbitrary three-dimensional coordinate system. The pressure data and particle motion data may be sent along the streamers and data transmission cables to the vessel 102, where the data may be stored electronically or magnetically on data-storage devices located onboard the vessel 102. The pressure data and particle motion data represent pressure and velocity wavefields and, therefore, may also be referred to as the pressure wavefield and velocity wavefield, respectively.

In FIG. 2, directional arrow 208 represents the direction of an up-going wavefield at the location of receiver 210 and dashed arrow 212 represents a down-going wavefield produced by an up-going wavefield reflection from the free surface 114 before reaching the receiver 210. In other words, the pressure wavefield p(\vec{x},t) is composed of an up-going pressure wavefield component and a down-going pressure wavefield component, and the velocity wavefield v_{\vec{n}}(\vec{x},t) is composed of an up-going velocity wavefield component and a down-going velocity wavefield component. The down-going wavefield contaminates pressure and particle motion velocity data and creates notches in the spectral domain. Filtering may be done to remove the down-going wavefields from the pressure and particle motion velocity data, leaving the up-going wavefields which are typically used to generate images of the subterranean formation.

As explained above, each pressure sensor and particle motion sensor generates seismic data that may be stored in data-storage devices located onboard the survey vessel. The seismic data measured by each pressure sensor or motion sensor is a time series that consist of a number of consecutively measured values called amplitudes separated in time by a sample rate. The time series measured by a pressure or motion sensor is called a “trace,” which may consist of thousands of samples with a sample rate of about 1 to 5 ms. A trace is a recording of a subterranean formation response to acoustic energy that passes from an activated source, into the subterranean formation where a portion of the acoustic energy is reflected and ultimately recorded by a sensor as described above. A trace records variations in a time-dependent amplitude that represents acoustic energy in the portion of the secondary wavefield measured by the sensor. In other words, each trace is a set of time-dependent pressure or motion sensor amplitudes denoted by trace(j)={A(j,tₖ)}ₖ₌₁^{K}, where j is the trace or receiver index, A(j,tₖ) is the amplitude of trace j at time sample tₖ, and K is the number of time samples in the trace.

As explained above, the secondary wavefield typically arrives first at the receivers located closest to the sources. The distance from the sources to a receiver is called the “source-receiver offset,” or simply “offset,” which creates a delay in the arrival time of a secondary wavefield from a substantially horizontal interface within the subterranean formation. A larger offset generally results in a longer arrival time delay. The traces are collected to form a gather that can be further processed using various seismic computational processing techniques in order to obtain information about the structure of the subterranean formation.

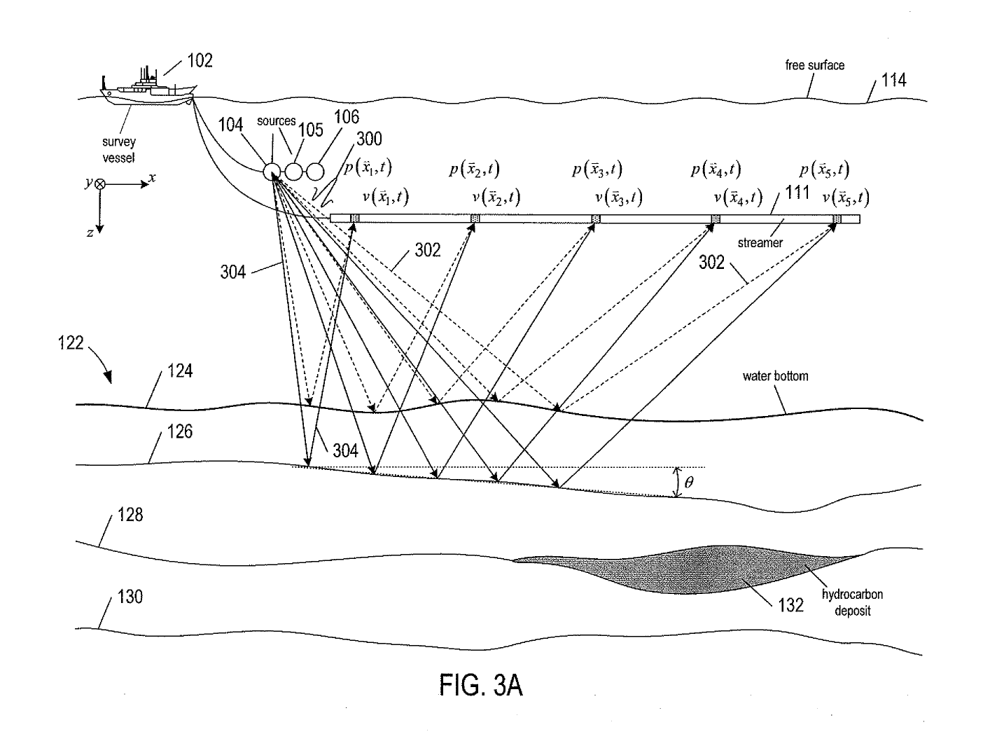

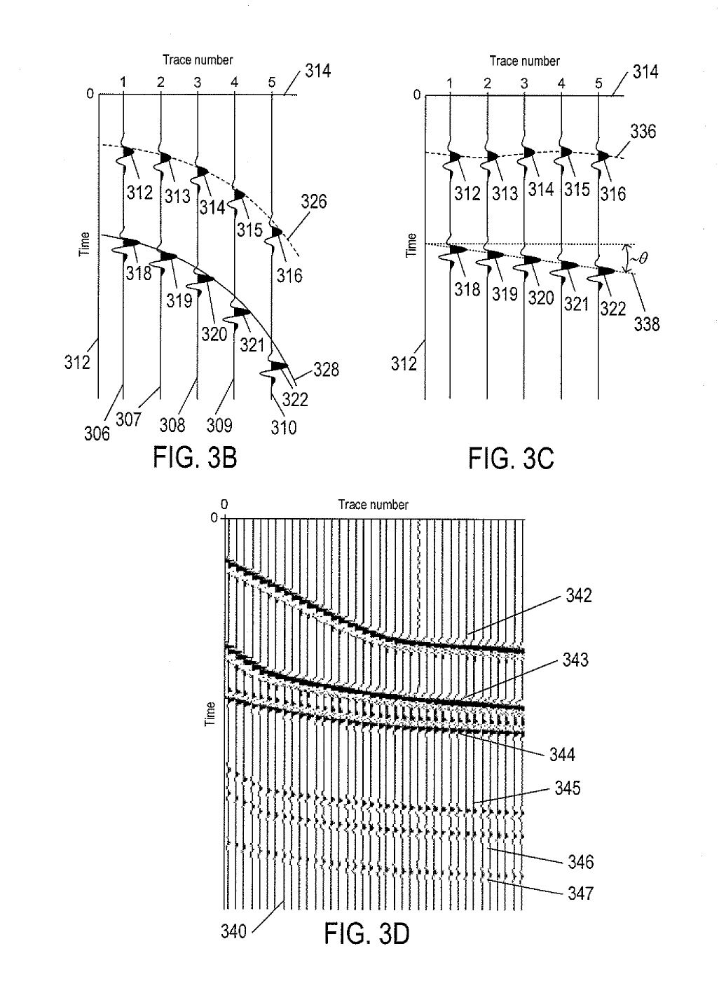

FIG. 3A shows example ray paths that represent paths of an acoustic signal 300 that travels from the first source 104 of the three sources into the subterranean formation 122. Dashed-line rays, such as rays 302, represent acoustic energy reflected from the surface 124 to the receivers located along the streamer 108, and solid-line rays, such as rays 304, represent acoustic energy reflected from the interface 126 to the receivers located along the streamer 108. Note that for simplicity of illustration only a hand full of ray paths are represented. Each pressure sensor measures the hydrostatic pressure and each motion sensor measures particle motion of the acoustic energy reflected from the formation 122. The hydrostatic pressure data p(\vec{x},t) and particle motion velocity data v_{\vec{n}}(\vec{x},t) generated at each receiver are time sampled and recorded as separate traces. In the example of FIG. 3A, the collection of traces generated by the receivers along the streamer 111 for a single shot from the source 104 form a “common-shot gather” or simply a “shot gather.” The traces generated by the receivers located along each of the other five streamers for the same shot may be collected to form separate shot gathers, each gather associated with one of the streamers.

FIG. 3B shows a plot of a shot gather composed of example traces 306-310 of the wavefield recorded by the five receives located along the streamer 111 shown in FIG. 3A. Vertical axis 312 represents time and horizontal axis 314 represents trace numbers with trace “1” representing the seismic data generated by the receiver located closest to the source 104 and trace “5” representing the seismic data generated by the receiver located farthest from the source 104. The traces 306-310 may represent variation in the amplitude of either the pressure data p(\vec{x},t) or the velocity data v_{\vec{n}}(\vec{x},t) recorded by corresponding sensors of the five receivers. The example traces include wavelets or pulses 312-316 and 318-322 that represent the up-going measured by the pressure sensors or motion sensors. Peaks, colored black, and troughs of each trace represent changes in the amplitude measured by the pressure sensors or motion sensors. The distances along the traces 306-310 from the trace number axis 314 (i.e., time zero) to the wavelets 312-316 represents the travel time of the acoustic energy output from the source 104 to the surface 124 and to the receivers located along the streamer 111, and wavelets 318-322 represents the longer travel time of the acoustic energy output from the source 104 to the interface 126 and to the same receivers located along the streamer 111. The amplitude of the peak or trough of the wavelets 312-316 and 318-322 indicate the magnitude of acoustic energy recorded by the pressure sensor or motion sensor.

The arrival times versus source-receiver offset is longer with increasing source-receiver offset. As a result, the wavelets generated by a surface or an interface may track a hyperbolic distribution and are collectively called a “reflected wave.” For example, dashed hyperbolic curve 326 represents the hyperbolic distribution of the wavelets 312-316 reflected from the surface 124 and are called a “surface reflected wave,” and solid hyperbolic curve 328 represents the hyperbolic distribution of the wavelets 318-322 from the interface 126 and are called an “interface reflected wave.”

The traces from different source-receiver pairs may be corrected during seismic data processing to remove the effects of different source-receiver offsets in a process called “normal moveout” (“NMO”). FIG. 3C shows a gather of the traces 330-334 after NMO has been applied to align the wavelets in time as represented by dashed-line curve 336 for the wavelets 312-316 and line 338 for the wavelets 318-323. Curve 336 approximates the curvature of the surface 124 below the streamer 111 shown in FIG. 3A, and line 338 approximates the curvature and dip angle θ of the interface 126 below the streamer 111 shown in FIG. 3A. The dip angle is the magnitude of inclination of a plane from horizontal. After NMO corrections, traces from different shot records with a common reflection point may be stacked to form a single trace during seismic data processing. Stacking may improve the signal-to-noise ratio, reduce noise, improve seismic data quality, and reduce the amount of data.

FIG. 3D shows an expanded view of a gather composed of 38 traces. Each trace, such as trace 340, varies in amplitude over time and represents acoustic energy reflected from the surface and five different interfaces within a subterranean formation as measured by a pressure sensor or a motion sensor. In the expanded view, wavelets that correspond to reflection from the same surface or interface of the subterranean formation appear chained together to form reflected waves. For example, wavelets 342 with the shortest transit time represent a surface reflected wave, and wavelets 343 represent an interface reflected wave emanating from an interface just below the surface. Reflected waves 344-347 represent reflections from interfaces located deeper within the subterranean formation.

In practice, a typical trace does not represent just primary reflections from a subterranean formation, as represented in FIGS. 3B-3D. In practice, a trace represents the time-dependant amplitude of acoustic energy associated with numerous reflections of acoustic energy from within the subterranean formation and includes primaries and multiples.

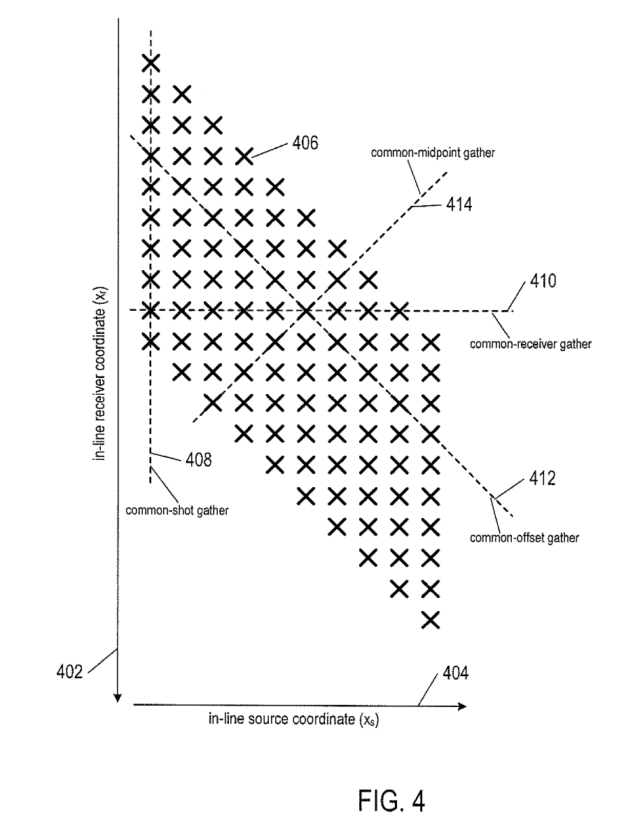

The gathers shown in FIG. 3B-3D are described for seismic data sorted into a common-shot domain. A domain is a collection of gathers that share a common geometrical attribute with respect to the seismic data recording locations. However, implementations of the method for attenuating noise in seismic data are not limited to seismic data sorted in the common-shot domain. The seismic data may be sorted into any suitable domain for examining the features of a subterranean formation including a common-offset domain, common-receiver domain, or common-midpoint domain. FIG. 4 shows a plot of different ways seismic data collected in a survey may be sorted into different types of domains. Vertical axis 402 represents the in-line receiver coordinates and horizontal axis 404 represents the in-line source coordinates. X's, such as X 406, represent where a recording (i.e., pressure or particle motion) has taken place. In this plot, a column of recordings identified by dashed line 408 represents a shot gather, and a row of recordings identified by dashed line 410 represents a common-receiver gather. Recordings collected along a diagonal represented by dashed line 412 is a common-offset gather and recordings collected along a diagonal represented by dashed line 414 is a common-midpoint gather.

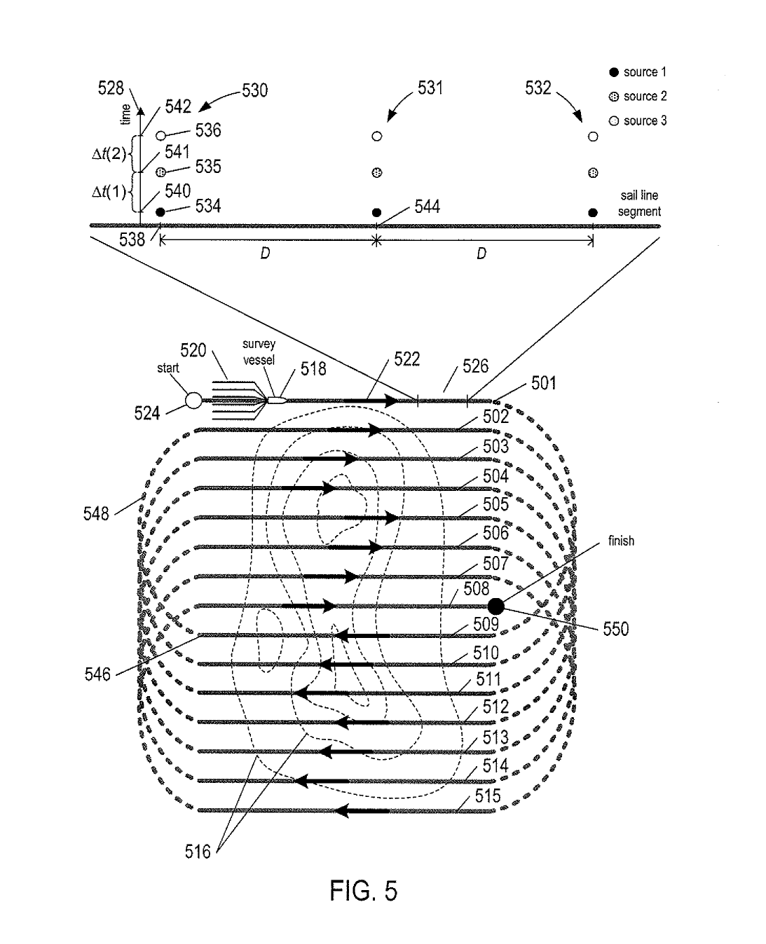

FIG. 5 shows a top view of sail lines 501-515 of a marine survey of a subterranean formation located beneath a body of water. Dashed line shapes 516 represent topographic contour lines of the formation. The subterranean formation 516 is surveyed to detect the presence and size of a petroleum reservoir located within the formation. In this example, a survey vessel 518 tows a set of streamers 520 and tows three sources (not shown) one after another, as shown in FIG. 1A, along the parallel sail lines 501-515. Directional arrows, such as directional arrow 522, represent the direction the survey vessel 518 travels along the sail lines. The survey begins at a start point 524. The survey vessel 518 activates the sources and stores the pressure and velocity wavefields measured by the receivers as the survey vessel 518 travels along each of the sail lines 501-515 at an approximately constant rate of speed. FIG. 5 includes a magnified view of a segment 526 of the sail line 501. The magnified view of the sail-line segment 526 includes a time axis 528. Three sets 530-532 of differently shaded dots each represent an activation sequence and relative times in which the three different sources are activated at approximately the same shot locations along the sail line 501. The distance between two shots that are considered to be activated at approximately the same location, d, may depend on the highest frequency in the measured data that is of interest, fᵢₙₜₑᵣₑₛₜ, and the velocity of sound in water, c. For example, this distance may be approximated as follows:

$$d = \frac{c}{2 \cdot {f}_{interest}}$$

Black dots, such as black dot 534, represent activation of a first source located closest to the survey vessel 518; shaded dots, such as shaded dot 535, represent activation of a second source located between the first source and the third source; and unshaded dots, such as unshaded dot 536, represent the activation of the third source located farthest from the survey vessel. In the example of FIG. 5, activation of the three sources is based on position. In other words, the sources are activated at shot locations separated by approximately the same distance D along the sail lines. For example, as the survey vessel 518 travels along the sail line 501, the first source is activated when the first source reaches a shot location 538 along the sail line 501, the second source is activated when the second source also reaches the shot location 538, and the third source is activated when the third source finally reaches the shot location 538. The times 540-542 when the sources are activated at the shot location 538 may be stored in the data-storage device located onboard the survey vessel 518. The source-activation times 540-542 are used to determine time delays Δt(1) and Δt(2), which may be different (i.e., Δt(1)≠Δt(2)) for a particular shot location and may vary from shot location to shot location due to changing environmental conditions, such as changes in wind speed or direction or changes in the water current. During each recording period, the secondary wavefields generated as a result of a sequence of source activations are measured and stored in the data-storage device. A recording period begins when a sequence of source activations 530 begins and the period ends when the survey vessel has travel the distance D along the sail line, which also marks the beginning of a subsequent recording period in which the sources are activated according to the sequence 531 as the three sources pass over a subsequent shot location 544.

In alternative implementations, the sources may be activated based on time. For example, when the first source is activated, the activation time and the shot location of the first source is recorded. When the second source approximately reaches the same shot location, the second source is activated and the activation time of the second source is recorded. When the third source approximately reaches the same shot location, the third source is activated and the activation time is recorded. The source-activation times 540-542 are used to determine time delays Δt(1) and Δt(2) between activation of the sources at the shot location. A first recording period, t_{D}, begins when an activation sequence of three sources begins and the period ends when the survey vessel has travel for the period t_{D} along the sail line, which also marks the beginning of a second recording period in which the sources are activated according to the same sequence at a subsequent shot location determined by the duration of the recording period t_{D}.

When the survey vessel 518 reaches the end of a sail line, the survey vessel 518 stops activating the sources and measuring and storing the wavefield and follows the path represented by an arc to a different sail line and begins activating the source and measuring and storing the wavefield. For example, at the end 546 of the sail line 509, the survey vessel 518 stops activating the sources and measuring and storing the wavefield, follows the path 548 to the sail line 502 and the survey vessel 518 activates the sources and measures and stores the wavefields along the sail line 502. The survey vessel 518 continues this pattern of activating the source and measuring and storing the wavefields along each of the sail lines 501-515 until the survey vessel 518 reaches a finish point 550 located at the end of the sail line 508.

The straight sail lines 501-515 shown in FIG. 5 represent an example of ideal straight paths traveled by a survey vessel. In practice, however, a typical survey vessel is subject to shifting currents, winds, and tides and may only be able to travel approximately parallel straight sail lines. In addition, the streamers towed behind a survey vessel may not be towed directly behind the survey vessel because the streamers are subject to changing conditions, such as weather and currents. As a result, the streamers may deviate laterally from the track in a process called “feathering.”

Sail lines are not restricted to straight sail lines described above with reference to FIG. 5. Sail lines can be curved, circular or any other suitable non-linear path. For example, in coil shooting surveys, a survey vessel travels in a series of overlapping, continuously linked circular, or coiled, sail lines. The circular shooting geometry acquires a full range of offset data across every azimuth to sample the subsurface geology in all directions.

For the sake of simplicity and brevity in the following description, three in-line sources are used to describe the manner in which the sources are activated at each shot location. However, implementations are not intended to be limited to activating just three sources at each shot location. In general, a survey vessel may tow any suitable number of n in-line sources, where n is a positive integer that may range from as few of two sources to more than three sources. Note that when n sources are activated one after another at approximately the same shot location, the n source-activation times are stored in the data-storage device in order to determine n−1 associated time delays Δt(i), where i is integer index ranging from 1 to n−1.

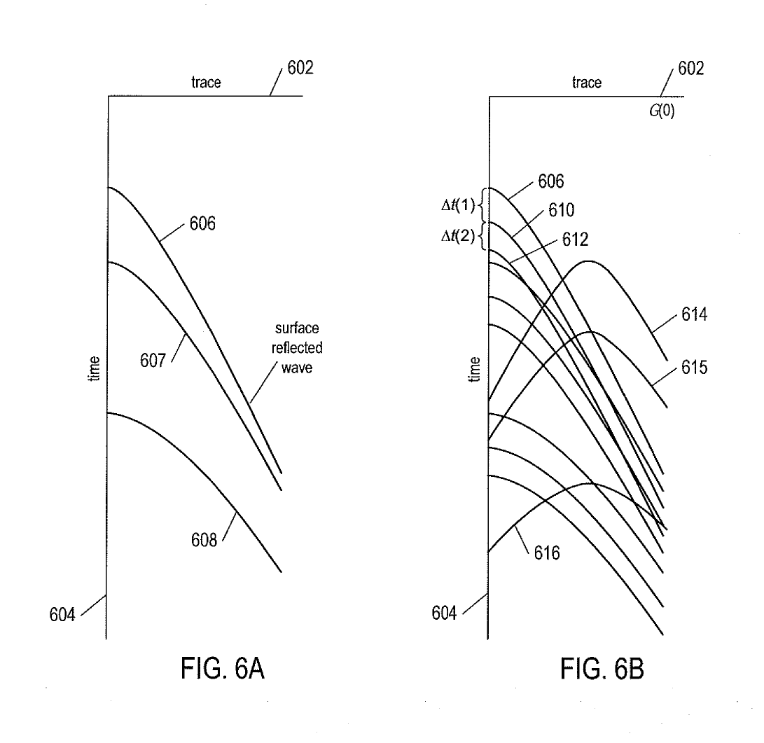

FIG. 6A shows an example of a shot gather associated with activation of one of three sources of the seismic data acquisition system described above. Horizontal axis 602 represents trace number axis and vertical axis 604 represents time. Curve 606 represents a surface reflected wave from the surface of a subterranean formation and curves 607 and 608 represent reflected waves from two interfaces within the formation.

FIG. 6B shows an example of a shot gather produced by all three sources activated according to an activation sequence at the same shot location, as described above with reference to FIG. 5. Because the three sources are activated at approximately the same shot location with shot time delays Δt(1) and Δt(2), the primary wavefields generated by the three sources enter the same region of the subterranean formation separated by the time delays Δt(1) and Δt(2) and the secondary wavefields reflected from the subterranean formation are reflected with approximately the same time delays Δt(1) and Δt(2). As a result, the pattern of reflected waves 606-608 in FIG. 6A is repeated three times to generate the reflected waves in FIG. 6B. For example, reflected waves 606, 610 and 612 in FIG. 6B represent secondary wavefield reflections from the same surface of the subterranean formation separated by the time delays Δt(1) and Δt(2). FIG. 6B also includes reflected waves 614-616 produced by another source, such as a source activated by a different survey vessel surveying an adjacent region of the subterranean formation. The reflected waves 614-616 are considered noise. The gather in FIG. 6B represents an initial gather and is denoted by G(0). The initial gather G(0) when originally constructed may contain a number of missing traces. Implementations may include applying trace interpolation to fill in missing traces, replace noisy traces, and produce evenly spaced traces in the initial gather G(0).

It should be noted that the reflected waves in FIG. 6B and in subsequent figures are synthetic and are intended to provide a simplistic representation as to how the wavefield data represented in a gather obtained from a sequence of source activations is altered by the operations comprising a computational method for attenuating noise in the wavefield described herein. In practice, gathers obtained from a sequence of source activations over the same region of an actual subterranean formation are composed of numerous overlapping reflected waves associated with primary and multiple reflections and noise and it may, in some cases, be impractical to visually examine the gather and identify the reflected waves associated with various features of the subterranean formation.

After the initial gather G(0) shown in FIG. 6B has been formed for a sequence of three source activations two additional time-shifted gathers are generated. A first time-shifted gather G(1) is produced by time shifting each of the traces comprising the initial gather G(0) by the time delay Δt(1). For example, the initial gather may be mathematically represented as a set of traces:

G(0)={trace(0,j)}ⱼ₌₁^{m}

where
trace(0,j)={A(j,tₖ)}ₖ₌₁^{K};
j is the trace index; and
m is the number of traces in the initial gather.
   The first time-shifted gather G(1) is given by:

G(1)={trace(1,j)}ⱼ₌₁^{m}

where

trace(1,j)={A(j,tₖ−Δt(1))}ₖ₌₁^{K}.

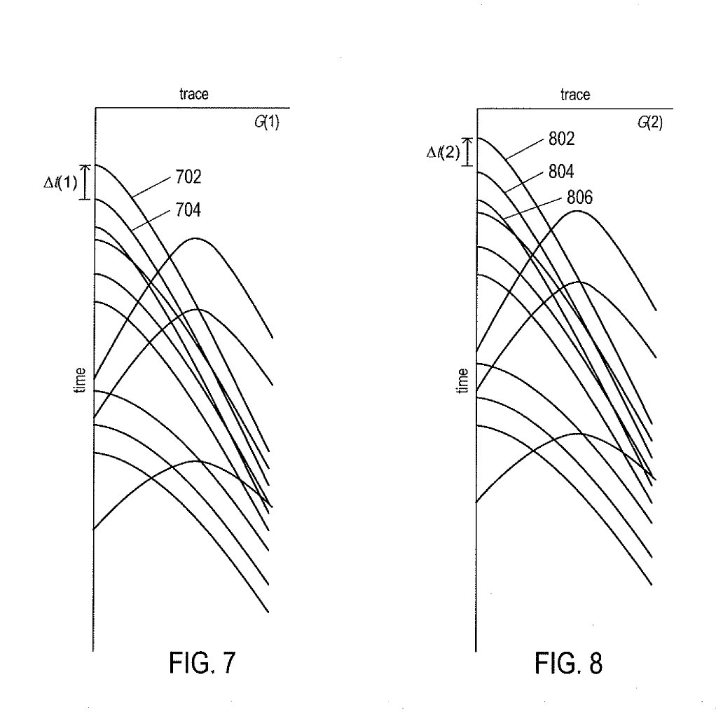

FIG. 7 shows a first time-shifted gather G(1) produced by time shifting the initial gather G(0) by the time delay Δt(1). The time-shifted gather G(1) is composed of all m traces of the initial gather G(0) time shifted by the time delay Δt(1). As a result, the reflected waves in the gather G(1) appear at early times than in the gather G(0). For example, a surface reflected wave 702 in FIG. 7 is the surface reflected wave 606 in FIG. 6B time shifted by the time delay Δt(1), and reflected wave 704 in FIG. 7 is the reflected wave 610 in FIG. 6B shifted by the time delay Δt(1). As a result, the reflected wave 704 is aligned in time with the surface reflected wave 606 in FIG. 6B.

A second time-shifted gather G(2) is produced by time shifting each of the traces comprising the first time-shifted gather G(1) by the time delay Δt(2). For example, the second time-shifted gather G(2) is given by:

G(2)={trace(2,j)}ⱼ₌^{ml}

where

trace(2,j)={A(j,tₖ−Δt(1)−Δt(2))}ₖ₌₁^{K}.

FIG. 8 shows a second time-shifted gather G(2) produced by time shifting the first time-shifted gather G(1) by the time delay Δt(2). The reflected waves in the second time-shifted gather G(2) appear at early times than in the first time-shifted gather G(1). For example, reflected waves 802 and 804 in FIG. 8 are the reflected waves 702 and 704 in FIG. 7 time shifted by the time delay Δt(2), and reflected wave 806 in FIG. 8 is the reflected wave 612 in FIG. 6B shifted by the time delays Δt(1) and Δt(2). As a result, the reflected wave 806 is aligned time with the surface reflected wave 606 in FIG. 6B.

In general, for n sources activated one after another at approximately the same shot location along a sail line, a set of n gathers, denoted by {G(i)}ᵢ₌₀ⁿ⁻¹, are produced. The set of gathers {G(i)}ᵢ₌₀ⁿ⁻¹ may belong to the shot domain, the common-offset domain, common-receiver domain, or the common-midpoint domain. The initial gather G(0) is not time shifted and is represented by:

G(0)={trace(0,j)}ⱼ₌₁^{m} (1)

where

trace(0,j)={A(j,tₖ)}

The time-shifted gathers G(i) are computationally generated according to the mathematical representation given by:

G(i)={trace(i,j)}ⱼ₌₁^{m} (2)

where

$$trace ( i , j ) = \{ A ( j , {t}_{k} - {\sum }_{l = 1}^{i} Δ t ( l ) ) \}$$

In other words, each time-shifted gather G(i+1) is generated by subtracting a sum of the time delays Σₗ₌₁ⁱΔt(1) from the time component tₖ of traces comprising the initial gather G(0).

After the set of gathers {G(i)}ᵢ₌₀ⁿ⁻¹ has been produced, a realization gather G is constructed by selecting in different traces from the gathers in the set {G(i)}ᵢ₌₀ⁿ⁻¹. Each trace used to construct the gather G is selected from one of the gathers in the set {G(i)}ᵢ₌₀ⁿ⁻¹. The operation of selecting in different traces from the gathers in the set {G(i)}ᵢ₌₀ⁿ⁻¹ may be represented in pseudo-code as follows:

| | |
|---|---|
| 1 | initialize G = Ø; //G is initially empty// |
| 2 | for j = 1 to m; |
| 3 | select G(i) from the set {G(i)}ᵢ₌₀ⁿ⁻¹; |
| 4 | retrieve trace(i, j) from G(i); |
| 5 | G = G + trace(i, j); |
| 6 | end for loop; |

The operation of selecting a gather G(i) from the set of gathers {G(i)}ᵢ₌₀ⁿ⁻¹ may be implemented in any one of many different ways. In one implementation, the gather index, i, may be selected at random from the set of integers {0, . . . , n−1} using a random number generator. When the m traces are selected at random from the set of gathers {G(i)}ᵢ₌₀ⁿ⁻¹, the number of possible realization gathers is mⁿ. For example, for an initial gather with 200 traces generated with three source activations a shot location 3²⁰⁰=2.7×10⁹⁵ realization gathers may be constructed. Alternatively, the gather index i may be selected in a systematic manner. For example, the gather index i may be initialized to zero. For each iteration of the for-loop, the gather index is incremented until i=n in which case the gather index i is reset to zero.

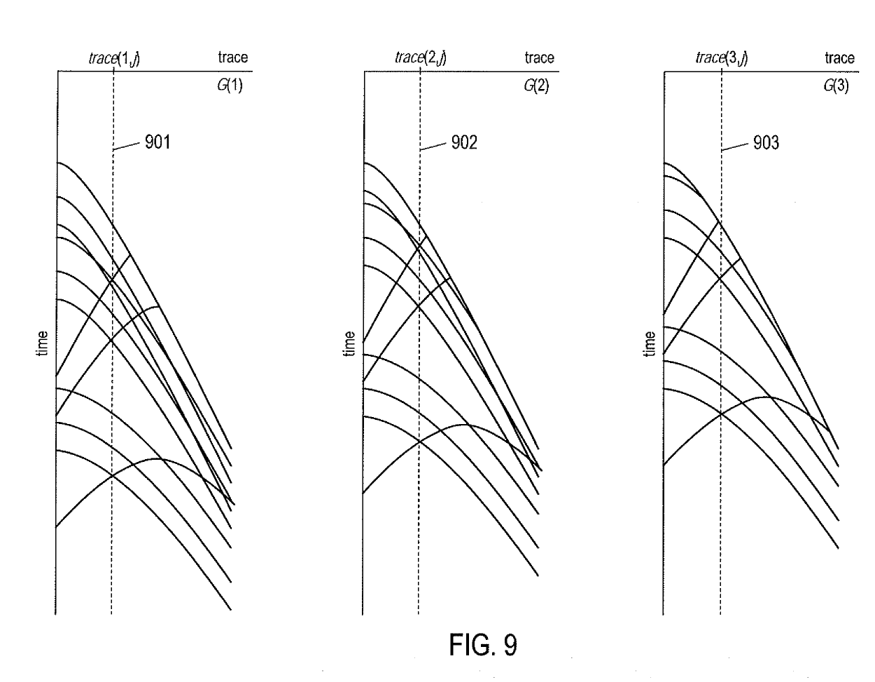

FIG. 9 shows the gathers G(0), G(1), and G(2). The jth traces trace(0,j), trace(1,j), and trace(2,j) of the gathers G(0), G(1), and G(2) are identified by dashed lines 901-903, respectively. In constructing the realization gather G, one of the traces trace(0,j), trace(1,j), and trace(2, j) is selected and used as the jth trace in the gather G.

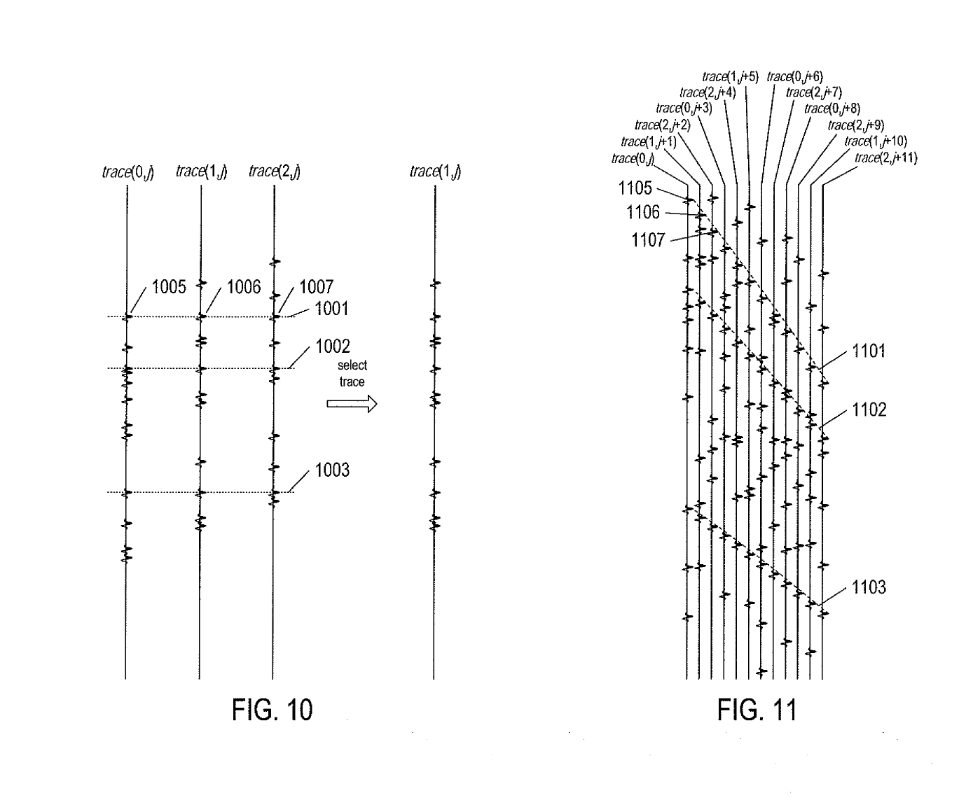

FIG. 10 shows a magnified view of the jth traces trace(0,j), trace(1,j), and trace(2,j) of the gathers G(0), G(1), and G(2), respectively. Note that even though the traces are from different time-shifted gathers, all three of the traces have wavelets that are aligned in time as indicated by dotted lines 1001-1003. The wavelets that are aligned in time represent acoustic energy reflected from the same point of a reflector of the subterranean formation. For example, the wavelets 1005-1007 represent acoustic energy reflected from the same point of the surface of the subterranean formation. Note that the remaining wavelets in the traces are not aligned in time. In other words, by time shifting the traces according to the time delays as described above with reference to FIGS. 7 and 8, each of the traces trace(0,j), trace(1,j), and trace(2,j) has wavelets that are aligned in time with corresponding wavelets in the reflected waves of the initial gather G(0) and the remaining wavelets in the traces will not be aligned.

The m traces selected from the gathers G(0), G(1), and G(2) to construct the realization gather G may be arranged in order of increasing trace index. Because traces in the gather G are selected from different gathers G(0), G(1), and G(2), the wavelets that are not aligned in time with the reflected waves in the initial gather G(0) appear scattered while the gather G includes wavelets that recreate the reflected waves in the initial gather G(0). FIG. 11 shows twelve consecutive traces randomly selected from the gathers G(0), G(1), and G(2). The twelve traces are arranged in order of increasing trace index which reveals patterns of wavelets that are aligned in time with reflectors from the same features of the subterranean formation as indicated by dashed curves 1101-1103. For example, the wavelets 1105-1107 are selected from the three gathers G(0), G(1), and G(2), respectively, and are part of the wavelets represented by dashed line 1101. The wavelets along dashed line 1101 correspond to secondary wavefield reflections from the surface of the subterranean formation and the wavelets along dashed lines 1102 and 1103 correspond to secondary wavefield reflections from the interfaces within the subterranean formation.

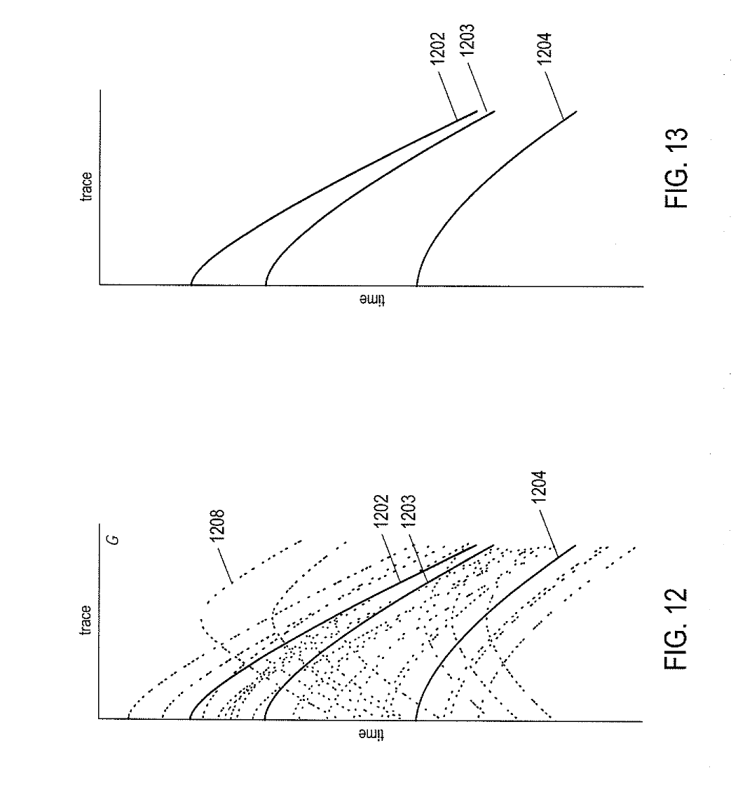

FIG. 12 shows an example of a realization gather G composed of m traces constructed from the gathers G(0), G(1), and G(2). Each trace is selected from one of the gathers G(0), G(1), and G(2) as described above. Reflected waves 1202-1204 are composed of wavelets present in all three of the gathers G(0), G(1), and G(2) and are aligned in time with the physical reflected waves 606-608 in FIG. 6B. FIG. 12 also includes dots, such as dot 1208, that correspond to the amplitudes or wavelets of traces present in at most two of the gathers G(0), G(1), and G(2). When comparing the example realization gather G to the initial gather G(0), the reflected waves associated with noise and the reflected waves resulting from activations of the second and third source appear broken and incomplete. As a result, the reflected waves 1202-1206 represent physical reflected waves that are distinguishable from broken up noise and broken up reflected waves resulting from other sources.

Next, a coherency filter may be use to identify the broken up amplitudes and muting may be used to zero the identified broken up amplitudes. The coherency filter can be implemented using inversion where the coherency filter may be repeated. FIG. 13 shows the realization gather G after muting has been used to zero amplitudes above the reflected wave 1202 and between the reflected waves 1202-1204.

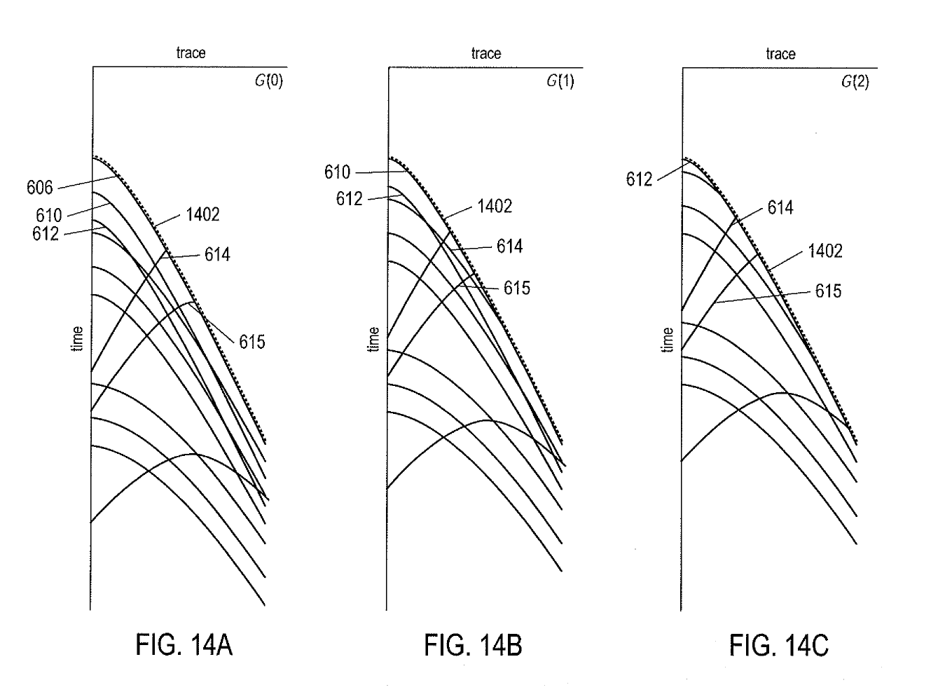

In other implementations, muting may be used after each time shift represented in FIGS. 7 and 8. For example, the reflected wave 606 in FIG. 6B may be identified as a muting front. Amplitude of traces with times less than the times associated with the muting front are muted (i.e., set equal to zero). FIGS. 14A-14C show an example of applying muting after the initial and time-shifted gathers are constructed. In FIGS. 14A-14C, dashed curve 1402 represents a muting front determined by the reflected wave 606 in FIG. 6B. In FIG. 14A, the gather G′(0) is generated by setting amplitudes of traces with times less than the muting front 1402 equal to zero. As a result, portions of the reflected waves 614 and 615 in FIG. 14B are missing. In FIG. 14B, the gather G′(1) is generated by time shifting the gather G′(0) by Δt(1) then setting amplitudes of traces with times less than the muting front 1402 equal to zero. In FIG. 14C, the gather G′(2) is generated by time shifting the gather G′(1) by Δt(2) then setting amplitudes of traces with times less than the muting front 1402 equal to zero.

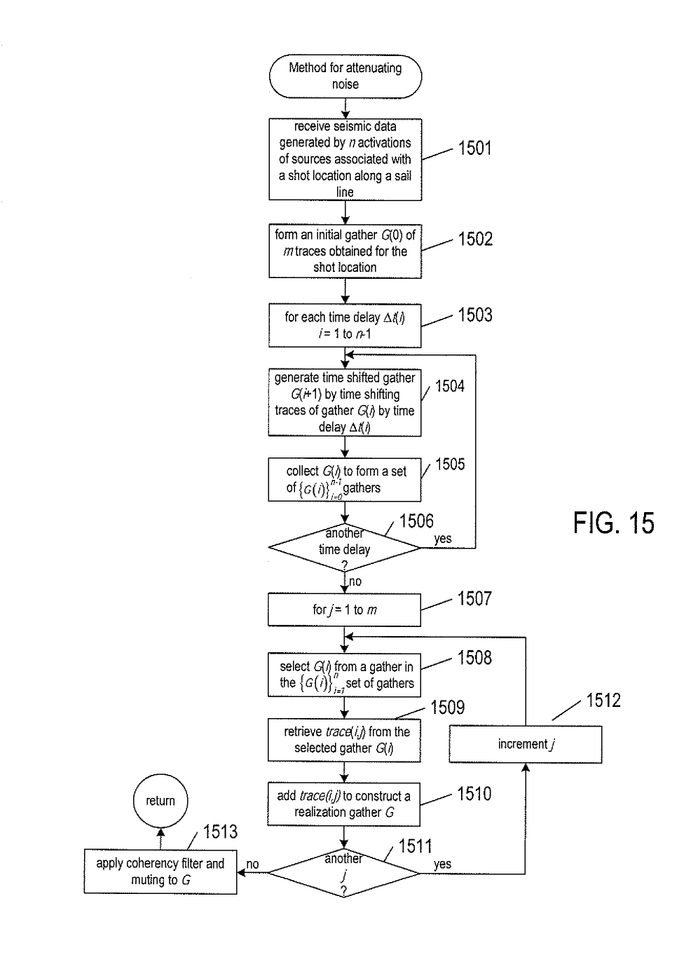

FIG. 15 shows a flow-control diagram of a computational routine for attenuating noise in seismic data obtained from n activations of a source at a shot location. In block 1501, seismic data generated by n activations of sources at substantially the same shot location along a sail line are received. The n activations are separated by n−1 time delays Δt(i). In block 1502, an initial gather G(0) with m traces obtained for the shot location is formed. The gather G(0) may be formed from simply collecting the seismic data measured by each of m receivers in a shot domain, common offset domain, common receiver domain, and a common midpoint domain. Formation of the gather G(0) may also include interpolation to restore missing traces and NMO to align wavelets in time. In a for-loop comprising blocks 1503-1506, the operations in blocks 1504-1506 are repeated for each time delay to construct n−1 time-shifted gathers. In block 1504, a time-shifted gather G(i+1) is generated by time shifting each of the m traces in the gather G(i) by time delay Δt(i), as described above with reference to Equation (2). In block 1505, the time-shifted gather constructed in block 1504 is added to a set of gathers {G(i)}ᵢ₌₀ⁿ⁻¹. In block 1506, if the time delays have not been exhausted, the operations in blocks 1504 and 1505 are repeated for a subsequent time delay. Otherwise, the method proceeds to the for-loop in blocks 1507-1511. In the for-loop comprising blocks 1507-1511, the operations in blocks 1508-1510 are repeated for each of the m traces. In block 1508, a gather G(i) is selected from the set {G(i)}ᵢ₌₀ⁿ⁻¹. The gather G(i) may be selected at random or selected using a systematic approach as described above. In block 1509, a trace trace(i,j) is copied from the gather G(i). In block 1510, the trace trace(i,j) is used to construct a realization gather G. In block 1511, if j is less than m the method proceeds to block 1512 in which j is incremented and the operations in blocks 1508-1511 are repeated. Otherwise, the method proceeds to block 1513 in which a coherency filter is applied to identify broken up wavelets and muting is applied to zero the amplitudes of the broken up wavelets.

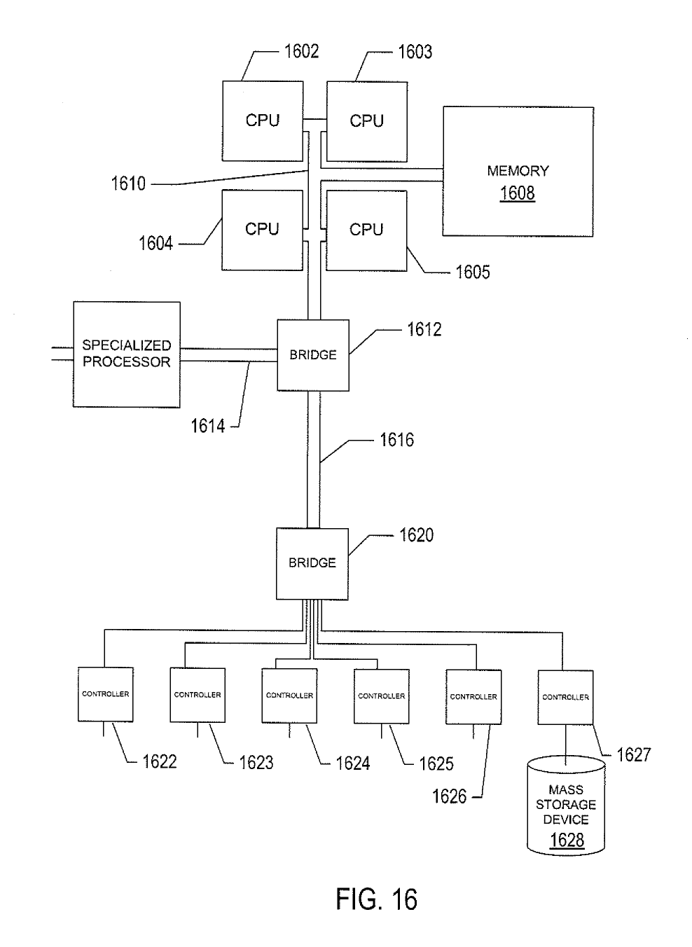

FIG. 16 shows an example of a generalized computer system that executes efficient methods for attenuating noise in seismic data and therefore represents a geophysical-analysis data-processing system. The internal components of many small, mid-sized, and large computer systems as well as specialized processor-based storage systems can be described with respect to this generalized architecture, although each particular system may feature many additional components, subsystems, and similar, parallel systems with architectures similar to this generalized architecture. The computer system contains one or multiple central processing units (“CPUs”) 1602-1605, one or more electronic memories 1608 interconnected with the CPUs by a CPU/memory-subsystem bus 1610 or multiple busses, a first bridge 1612 that interconnects the CPU/memory-subsystem bus 1610 with additional busses 1614 and 1616, or other types of high-speed interconnection media, including multiple, high-speed serial interconnects. The busses or serial interconnections, in turn, connect the CPUs and memory with specialized processors, such as a graphics processor 1618, and with one or more additional bridges 1620, which are interconnected with high-speed serial links or with multiple controllers 1622-1627, such as controller 1627, that provide access to various different types of computer-readable media, such as computer-readable medium 1628, electronic displays, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 1628 is a data-storage device, including electronic memory, optical or magnetic disk drive, USB drive, flash memory and other such data-storage device. The computer-readable medium 1628 can be used to store machine-readable instructions that encode the computational methods described above and can be used to store encoded data, during store operations, and from which encoded data can be retrieved, during read operations, by computer systems, data-storage systems, and peripheral devices.

The computational method described above with reference to FIG. 5-16 may be implemented in real time on board a survey vessel while a survey is being conducted. For example, an initial gather may be generated for a shot location of a sail line. When the survey vessel begins a sequence of activations at a subsequent shot location, time-shifted gathers for the previous shot location may be generated and used to generate a realization gather for the previous shot location.

Although the above disclosure has been described in terms of particular embodiments, it is not intended that the disclosure be limited to these embodiments. Modifications within the spirit of the disclosure will be apparent to those skilled in the art. For example, any of a variety of different implementations of noise attenuation can be obtained by varying any of many different design and development parameters, including programming language, underlying operating system, modular organization, control structures, data structures, and other such design and development parameters. Although implementations are described above for marine surveys with towed sources and streamers, implementations are not intended to be limited to such marine surveys. The computational systems and methods described above for attenuating noise may also be applied to seismic data produced by ocean bottom seismic techniques. One example of these techniques is implemented with ocean bottom cables (“OBCs”). The OBCs are similar to the towed streamer cables described above in that the OBCs include a number of spaced-apart receivers, such as receivers deployed approximately every 25 to 50 meters, but the OBCs are laid on or near the surface 124 shown in FIG. 1A. The OBCs may be electronically connected to an anchored recording vessel that provides power, instrument command and control, and data telemetry of the sensor data to the recording equipment on board the vessel. Alternatively, ocean bottom seismic techniques can be implemented with autonomous systems composed of receivers that are deployed and recovered using remote operated vehicles. The receivers may be placed on or near the surface 124 in a fairly coarse grid, such as approximately 400 meters apart. Autonomous receiver systems are typically implemented using one of two types of receiver systems. A first receiver system is a cable system in which the receivers are connected by cables to each other and are connected to an anchored recording vessel. The cabled systems have power supplied to each receiver along a cable, and seismic data are returned to the recording vessel along the cable or using radio telemetry. A second receiver system uses self-contained receivers that have a limited power supply, but the receivers typically have to be retrieved in order to download recorded seismic data. Whether using OBCs or autonomous receivers, source vessels equipped with two or more sources are operated as described above with reference to FIGS. 1A and 1B to generate acoustic signals at substantially the same shot location. It should also be note that implementations are not intended to be limited to marine surveys. The computational methods and systems described above for attenuating noise is seismic may be applied to land-based surveys. For a land based survey, the sources and receivers are disposed on land and the sources may be repeatedly activated at approximately the same location with time delays as described above for the marine survey.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method for generating noise attenuated seismic data obtained from a marine survey comprising:
towing two or more sources and one or more sensors through a body of water above a subterranean formation;
for each shot location,
activating the two or more sources one at a time at approximately the same shot location;
receiving seismic data from the sensors;
forming an initial gather of traces from the seismic data;
generating time-shifted gathers based on the initial gather and time delays between activation of the two or more sources;
constructing a realization gather from traces selected from the initial gather and the time-shifted gathers; and
storing the realization gather in a data-storage device.

2. The method of claim 1, wherein the two or more sources are towed in line one after another.

3. The method of claim 1, wherein the seismic data is pressure sensor data.

4. The method of claim 1, wherein the seismic data is particle motion sensor data.

5. The method of claim 1, wherein generating the time-shifted gathers further comprises for each time delay, generating a time-shifted gather by time shifting traces of the initial gather by a sum of previous time delays.

6. The method of claim 5, wherein generating the time-shifted gather further comprises subtracting the sum of previous time delays from a time index of the initial gather.

7. The method of claim 1, wherein constructing the realization gather further comprises selecting traces at random from the initial gather and the time-shifted gathers.

8. The method of claim 1, wherein constructing the realization gather further comprises systematically selecting traces from the initial gather and the time-shifted gathers.

9. The method of claim 1, wherein the data-storage device is located onboard a survey vessel.

10. The method of claim 1, further comprises coherency filtering to identify noise and broken up amplitudes; and muting to remove identified broken up amplitudes.

11. A computer system for attenuating noise in seismic data, the system comprising:
one or more processors;
one or more data-storage devices; and
a routine stored in one or more of the one or more data-storage devices and executed by the one or more processors, the routine directed to
receiving seismic data generated by sensors in response to one or more sources activated at approximately the same location with a time delay between each activation;
forming an initial gather of traces from the seismic data;
generating time-shifted gathers based on the initial gather and time delays between activation of the two or more sources;
constructing a realization gather from traces selected from the initial gather and the time-shifted gathers; and
storing the realization gather in the one or more data-storage devices.

12. The system of claim 11, wherein generating the time-shifted gathers further comprises for each time delay, generating a time-shifted gather by time shifting traces of the initial gather by a sum of previous time delays.

13. The system of claim 12, wherein generating the time-shifted gather further comprises subtracting the sum of previous time delays from a time index of the initial gather.

14. The system of claim 11, wherein constructing the realization gather further comprises selecting traces at random from the initial gather and the time-shifted gathers.

15. The system of claim 11, wherein constructing the realization gather further comprises systematically selecting traces from the initial gather and the time-shifted gathers.

16. The system of claim 11, wherein the data-storage device is located onboard a survey vessel.

17. The system of claim 11, further comprises coherency filtering to identify noise and broken up amplitudes; and muting to remove identified broken up amplitudes.

18. The system of claim 11, wherein the seismic data is generated by sensors located in one or more streamers towed by a survey vessel in response to activation of the one or more sources activated at approximately the same location of a sail line in a marine survey.

19. The system of claim 11, wherein the seismic data is generated by sensors located in ocean bottom cables in response to the one or more sources activated at approximately the same location.

20. The system of claim 11, wherein the seismic data is generated by sensors of a land-based survey in response to one or more sources activated at approximately the same location.

21. A physical computer-readable medium having machine-readable instructions encoded thereon for enabling one or more processors of a computer system to perform the operations of
receiving seismic data stored in one or more data-storage devices, the seismic data generated by sensors in response to one or more sources activated at approximately the same location with a time delay between each activation;
forming an initial gather of traces from the seismic data;
generating time-shifted gathers based on the initial gather and time delays between activation of the two or more sources;
constructing a realization gather from traces selected from the initial gather and the time-shifted gathers; and
storing the realization gather in the one or more data-storage devices.

22. The medium of claim 21, wherein generating the time-shifted gathers further comprises for each time delay, generating a time-shifted gather by time shifting traces of the initial gather by a sum of previous time delays.

23. The medium of claim 22, wherein generating the time-shifted gather further comprises subtracting the sum of previous time delays from a time index of the initial gather.

24. The medium of claim 21, wherein constructing the realization gather further comprises selecting traces at random from the initial gather and the time-shifted gathers.

25. The medium of claim 21, wherein constructing the realization gather further comprises systematically selecting traces from the initial gather and the time-shifted gathers.

26. The medium of claim 21, wherein the data-storage device is located onboard a survey vessel.

27. The medium of claim 21, further comprises coherency filtering to identify noise and broken up amplitudes; and muting to remove identified broken up amplitudes.

28. The medium of claim 21, wherein the seismic data is generated by sensors located in one or more streamers towed by a survey vessel in response to the one or more sources activated at approximately the same location of a sail line in a marine survey.

29. The medium of claim 21, wherein the seismic data is generated by sensors located in ocean bottom cables in response to the one or more sources activated at approximately the same location.

30. The medium of claim 21, wherein the seismic data is generated by sensors of a land-based survey in response to the one or more sources activated at approximately the same location.
